(19) United States
(12) Patent Application Publication
(10) Pub. No.: US 2003/0007141 A1
(43) Pub. Date: Jan. 9, 2003

(54) Apparatus and method for reducing transmission noise inteference of scanner

(76) Inventor: Kuo-Jeng Wang, Kaohsiung (TW)

Correspondence Address: J.C. Patents, Inc., Suite 114, 1340 Reynolds Ave., Irvine, CA, 92614, US

(21) Appl. No.: 09/898,409

(22) Filed: Jul. 3, 2001

(51) Int. Cl. G03B 1/00

(52) U.S. Cl. 355/133

(57) ABSTRACT

An apparatus to reduce the transmission noise interference of a scannerhas a charge coupled device, a shield circuit and a charge coupled device cable. Image analog signals are output from the charge coupled device. The shield circuit is coupled to the charge coupled device to filter the unwanted analog signal output from the charge coupled device, and to reserve the required analog signal. The charge coupled device is coupled to the shield circuit to transmit the required analog signal.

### BACKGROUND OF THE INVENTION

1. Field of the Invention

The invention relates in general to an apparatus and a method for transmission noise interference reduction. More particularly, the invention relates to an apparatus and a method to reduce the transmission noise interference of a scanner.

2. Related Art of the Invention

FIG. 1 shows a block diagram of a conventional scanner. The charge coupled device (CCD) 102 transmits the image analog signal to the analog-to-digital converter (ADC) 106 via the charge coupled device cable 104. The analog signal is converted into a digital signal, and the recovered digital signal is transmitted to the application specific integrated circuit (ASIC) 108 for processing before being output. As the amount of data the resolution of the image increase, most of the signals output from the charge coupled device 102 are high frequency analog signals. In the process of transmitting the image analog signal to the analog-to-digital converter 110 via the charge coupled device 102, the analog signal is easily interfered with by external noise due to its high frequency. When the length of the transmission cable is too long, a noise is easily caused to distort the signal.

### SUMMARY OF THE INVENTION

The invention provides an apparatus to reduce the transmission noise interference of a scanner, so that the problem of noise interference is resolved.

The apparatus to reduce the transmission noise interference of the scanner comprises a charge coupled device, a shield circuit and a charge coupled device cable. The charge coupled device converts the detected light intensity into a photocurrent by photoelectric conversion. The photocurrent is stored in the electrode, transformed into a signal charge and converted into various potential differences to output an analog signal. The shield circuit is coupled to the charge coupled device to filter the unwanted analog signal output from the charge coupled device, and to reserve the required analog signals. The charge coupled device cable is coupled to the shield circuit to transmit the required analog signals.

In the above embodiment, the shield coupled to the charge coupled device and the charge coupled device cable include a multiplexer and an AND gate. The multiplexer is coupled to the charge coupled device and is used to output a shield signal. The AND gate is coupled to the charge coupled device. The multiplexer and the charge coupled device apply the shield signal, so that unwanted analog signals are filtered and the required analog signals are reserved.

The above shield signal is an adjustable signal. At a high potential, the required analog signal is retained, and at a low potential, the unwanted analog signals are filtered out.

The invention also provides a method to reduce the transmission noise interference for a scanner. In the above method, a shield signal is used to filter the unwanted analog signal and retain the required analog signal during the signal transmission process of a scanner.

Thus, the unwanted analog signals are filtered away to leave only the required analog signals. The frequency of the analog signals is also reduced; that is, it is less likely to be interfered with by the noise.

### BRIEF DESCRIPTION OF THE DRAWINGS

These, as well as other features of the present invention, will become more apparent upon reference to the drawings wherein:

FIG. 1 shows a block diagram of the conventional scanner;

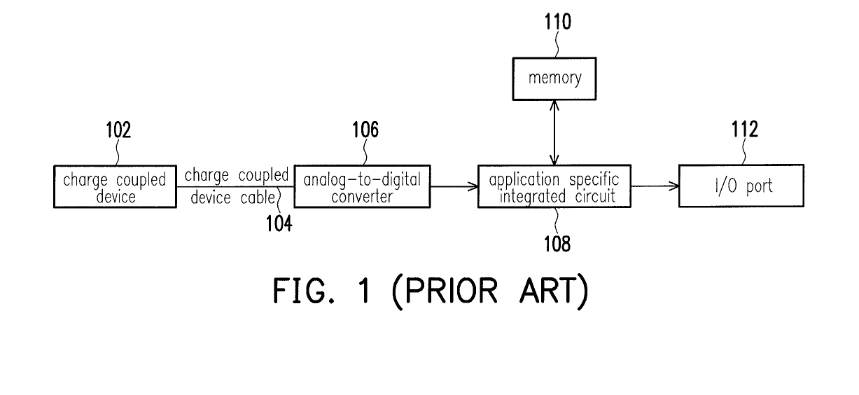

FIG. 2 shows a block diagram of a scanner applying the apparatus provided by the invention;

FIG. 3 shows the signal diagram of FIG. 2; and

FIG. 4 shows an embodiment of the shield circuit.

### DETAILED DESCRIPTION OF THE PREFERRED EMBODIMENT

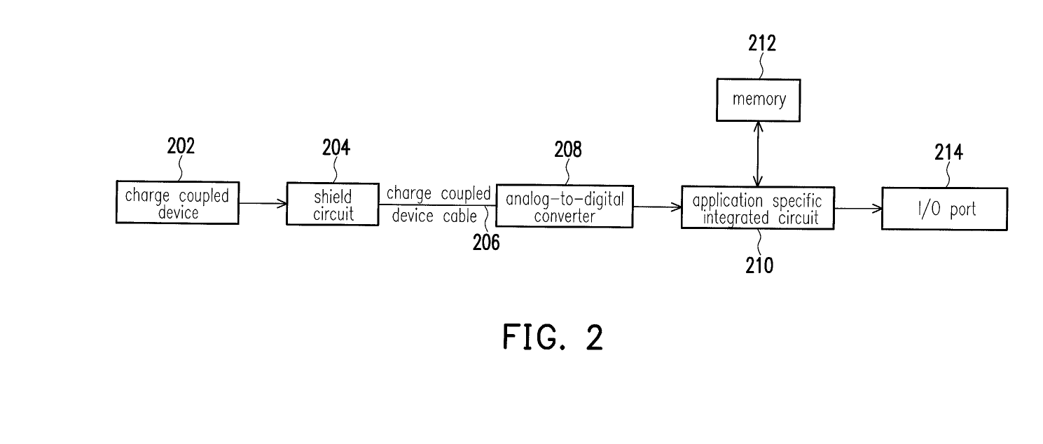

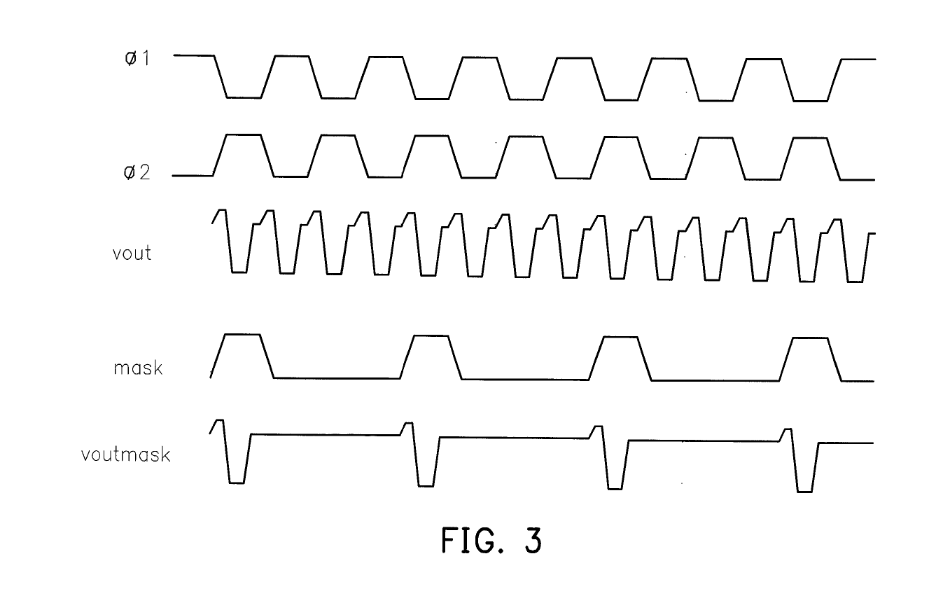

FIG. 2 shows a block diagram of a scanner applying the apparatus provided by the invention. The scanner comprises a charge coupled device 120, an analog-to-digital converter 106, a charge coupled device cable 104, an application specific integrated circuit (ASIC) 108, an analog-to-digital converter 106, a memory 110 and an input/output (I/O) port 112. The charge coupled device 120 is coupled to the charge coupled device cable 104. The application specific integrated circuit 108 is coupled to the analog-to-digital converter 106. The memory 110 is coupled to the application specific integrated circuit 108. The input/output port 112 is coupled to the application specific integrated circuit 108. The unwanted analog signals of the image analog signals are filtered away by the shield circuit 204 of the charge coupled device 202, while only the required analog signals remain. Referring to FIG. 3, the signal diagram generated by the apparatus in FIG. 2 is illustrated. φ₁ and φ₂ are the operation frequencies for image transmission of the charge coupled device 202. The charge coupled device 202 transmits the image analog signal Vout to the shield circuit 204, which then outputs an adjustable shield signal mask to Vout. When the signal mask is at a low level, the unwanted signal of the Vout is filtered. When the signal mask is at a high level, the required signal voutmask remains and is transmitted to the analog-to-digital converter 208 via the charge coupled device cable 206. The analog signal is converted into a digital signal, which is then recovered and transmitted to the application specific integrated circuit 210 for processing, and then output from the input/output port 112.

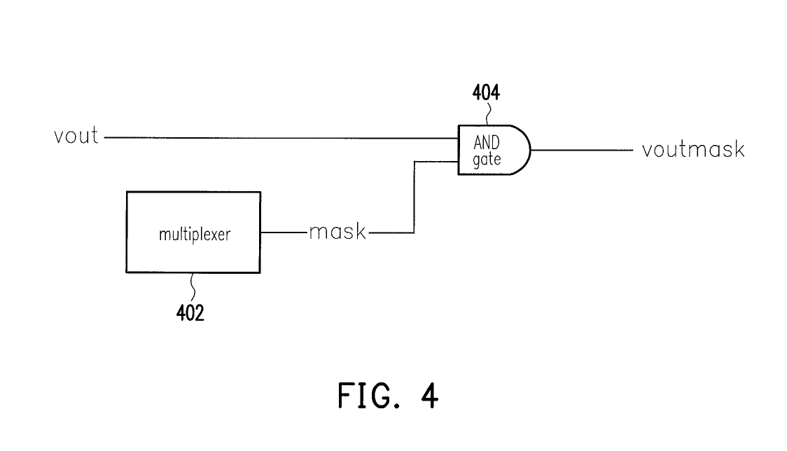

In FIG. 4, an embodiment of the shield circuit is illustrated. The multiplexer 402 generates an adjustable shield signal mask to the AND gate 404. After receiving the shield signal mask from the multiplexer 402 and the receiving signal vout of the charge coupled device, the shield signal mask is used to remove the unwanted part of the shield signal vout to generate a signal voutmask with a lower frequency. Since the output frequency is lowered, it is thus less likely to be interfered with by noise.

According to the above, the invention has the following advantages. The unwanted analog signal of the charge coupled device is filtered out, while the required analog signal is retained. As a result, the frequency of the analog signal is reduced without being easily affected by the noise interference.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An apparatus of reducing transmission noise interference of a scanner, comprising:
a charge coupled device, to convert a detected light intensity into a photocurrent by performing a photoelectric conversion, to store the photocurrent in an electrode as a signal charge, and to output an analog signal after converting the signal charge into a potential difference;
a shield circuit, coupled to the charge coupled device to filter out an unwanted analog signal and to retain a required analog signal of the charge coupled device; and
a charge coupled device cable, coupled to the shield circuit to transmit the required analog signal.

2. The apparatus according to claim 1, wherein the shield circuit coupled to the charge coupled device and the charge coupled device cable comprises:
a multiplexer, coupled to the charge coupled device to output a shield signal; and
an AND gate, coupled to the charge coupled device, the multiplexer and the charge coupled device cable, to filter out the unwanted analog signal using the shield signal, and to retain the required analog signal.

3. The apparatus according to claim 1, wherein the shield signal is an adjustable signal.

4. The apparatus according to claim 1, wherein the required analog signal is retained when the shield signal is at a high level, and the unwanted analog signal is filtered out when the shield signal is at a low level.

5. A method of reducing transmission noise interference for a scanner, comprising using a shield signal to filter away an unwanted analog signal and to retain a required analog signal during a signal transmission process of the scanner.

6. The method according to claim 5, wherein the shield signal includes an adjustable signal.

7. The method according to claim 5, wherein the required analog signal is retained when the shield signal is at a high level, and the unwanted analog signal is filtered out when the shield signal is at a low level.
